(19) United States
(12) Patent Application Publication
(10) Pub. No.: US 2020/0364671 A1
(43) Pub. Date: Nov. 19, 2020

(54) Automated Determination of Models for High Performers, and Automated Communications with Desirable Candidates

(71) Applicant: Rewired Solutions Inc., Sarasota, FL (US)

(72) Inventors: Timothy G Hearon, Sarasota, FL (US); Alan Wells, Arcadia, FL (US); Claudia Manes, Miami, FL (US)

(21) Appl. No.: 16/766,171

(22) PCT Filed: Nov. 18, 2018
(86) PCT No.: PCT/US2018/061713

§ 371 Date: May 21, 2020

Related U.S. Application Data
(60) Provisional application No. 62/590,095, filed on Nov. 22, 2017.

(51) Int. Cl. G06Q 10/10; G06Q 30/02

(52) U.S. Cl. CPC G06Q 10/1053; G06Q 30/0251

(57) ABSTRACT

Embodiments of the present invention provide a system for recruiting employment candidates likely to be successful in a targeted position, comprising (a) a success profile builder, comprising a programmed computer that determines characteristics of individuals in positions similar to the targeted position; (b) a hero persona builder, comprising a programmed computer that determines correlations between characteristics determined by the success profile builder and likelihood of success in the targeted position to produce one or more hero personas for the targeted position, and that determines communications channels likely to engage individuals who are similar to a hero persona; (c) a campaign builder, comprising a programmed computer that determines communications regarding the position from a hero persona, and matches the communications to communications channels for the hero persona.

### BACKGROUND

### Technical Field

The present invention is related to the field of automated methods and apparatuses that determine non-intuitive correlations among personal, professional and psychometric traits to project an individual's likelihood of success in a task, and to determine communications content and channels likely to reach such individuals.

### Background

Historically, the hiring process has relied upon the same fundamental steps for the last 200 years, despite the significant changes which have taken place in industry, society, and technology during that period. Employers made it known that a job was available by “posting” a job notice on a signboard visible to the public, individuals who were looking for jobs saw the notice and responded to the employer (while people who were regularly employed mostly ignored it), and the “talent acquisition process” only began in earnest once a candidate applied for the posted job. As organizations grew in size and complexity, the proverbial “help wanted sign” gave way to professional recruiters who developed job requisitions with more detailed specifications which were still “posted”—sometimes literally, on a sign or old fashioned bulletin board, sometimes to a broader audience in help wanted sections of general circulation newspapers or more specialized trade publications as print media became more widespread, or in our current internet Age, sometimes virtually and electronically on massive internet recruiting sites. Then, like generations of employers before them, they wait and hope for the perfect candidate to magically find that one job and apply for it. This “post and pray” model fails both employers and candidates in their quest to find the right fit.

For talent acquisition to be effective, recruitment needs to begin long before a candidate applies for a job. It needs to begin before that individual even knows they want a new job. Before the advent of modern technologies, large employers often sent teams of recruiters to travel the country and physically appear at campus career events, industry job fairs and other recruiting events in a direct effort to promote the prestige of their brand, the quality of their corporate culture, the superior working conditions they offer, or other favorable attributes. These recruiters were tasked with engaging potential recruits, motivating them to consider the employer's career opportunities, and converting them into job applicants. While major employers have long understood the need to market career opportunities to potentially valuable candidates, the tools at their disposal have always been labor intensive and the results and return on investment generated from them have always been difficult to quantify. In other cases, where a high-level executive or technical position has required a candidate with a specific set of attributes not commonly available from a random pool of job seekers, companies have been able to target their marketing efforts by outsourcing candidate searches to high end recruiting firms. These firms used their knowledge of job attributes, industry and professional contacts, and ability to network to identify and personally contact likely candidates, determine their level of interest, and engage them in the recruitment process. While the return on investment from this kind of process is easier for a company to determine, it is still a slow, expensive and labor-intensive process, and depends entirely on the personal skill and judgment of the recruiters involved and the quality of their personal networks.

### BRIEF DESCRIPTION OF THE DRAWINGS

FIG. 1 is a schematic illustration of implementation of elements of an example embodiment of the present invention.

FIG. 2 is a schematic illustration of implementation of elements of an example embodiment of the present invention.

FIG. 3 is a schematic illustration of implementation of elements of an example embodiment of the present invention.

FIG. 4 is a process flow diagram of an example embodiment of the present invention.

FIG. 5 is a system diagram of an example embodiment of the present invention.

### DESCRIPTION OF THE INVENTION

Embodiments of the present invention provide a system for recruiting employment candidates likely to be successful in a targeted position, comprising (a) a success profile builder, comprising a programmed computer that determines characteristics of individuals in positions similar to the targeted position; (b) a hero persona builder, comprising a programmed computer that determines correlations between characteristics determined by the success profile builder and likelihood of success in the targeted position to produce one or more hero personas for the targeted position, and that determines communications channels likely to engage individuals who are similar to a hero persona; (c) a campaign builder, comprising a programmed computer that determines communications regarding the position from a hero persona, and matches the communications to communications channels for the hero persona.

In some embodiments, the campaign builder monitors engagement by potential candidates with the communications, and adjusts the communications contents, the channels, the timing of communications, or a combination thereof, responsive to such monitored engagement.

In some embodiments, the hero persona builder comprises a computer-implemented machine learning tool.

In some embodiments, the success profile builder comprises a computer-implemented survey, and a computer-implemented data mining tool that mines personal, professional, and psychometric traits of current employees, candidates, or a combination thereof.

In some embodiments, the campaign builder comprises computer-implemented machine learning that determines preferred advertising content and channels responsive to the hero persona(s) and characteristics of similar personas in other campaigns.

Embodiments of the present invention provide a method of recruiting employment candidates likely to be successful in a targeted position, comprising: (a) identifying characteristics likely to be relevant to success in the targeted position, or to successful communication with a candidate; (b) producing a success profile, comprising personality, professional, demographic, and social media characteristics, from the characteristics determined in step (a); (c) identifying individuals who are in positions similar to the targeted position, and building a database comprising each such individual's quantifiable facts relative to the success profile; (d) using a computer model to determine from the database correlations among specific facts in the success profile and likelihood of success in the targeted position; (e) using a computer model to determine from the correlations one or more hero personas, where a hero persona comprises a specific set of facts, or range of facts, from the success profile, that is likely to correlate with success in the targeted position; (f) using a model such as a k-nearest neighbor model to identify which persona(s) are most aligned with individuals currently successful in the position;

(g) using the persona(s) identified, determining advertising content and channels likely to reach individuals likely to be successful in the position; (h) accepting input from candidates, and determining whether each candidate is desirable responsive to the candidate's input and the success profile.

Embodiments of the present invention provide an apparatus for identifying and communicating with candidates for a position, comprising: (a) a first discovery engine comprising a programmed computer configured to accept a specification of the position, and to use programmed rules to product a discovery questionnaire, and then to accept responses to the discovery questionnaire and produce a position outline; (b) a second discovery engine comprising a programmed computer configured to accept response to the discovery questionnaire and produce a hero survey, and then to collect responses to the hero survey and to analyze those responses and characteristics of the respondents and produce a hero persona; (c) a campaign build engine, comprising a programmed computer configured to accept the hero persona, the position outline, and specification of other communication campaigns, and produce a campaign profile comprising three or more of candidate questions, scoring key, ad budget, ad channels, ad audiences, ad creative, and messaging content; (d) a candidate matching engine, comprising a programmed computer configured to accept information from a prospective candidate and the hero persona and produce a profile similarity index that corresponds to the candidate's fit with the hero persona; (e) a digital strategy engine comprising a programmed computer configured to accept the campaign profile and the position outline, the hero persona, or both; and to deploy the campaign according to the campaign profile, where deploying the campaign comprises one or more of placing ads, communicating to prospective candidates, accepting profile similarity indices from prospective candidates to adjust the campaign profile responsive to the profile similarity indices. In some embodiments, the programmed computer in at least two of elements (a)-(e) is the same programmed computer. In some embodiments, the programmed computer of at least two of elements (a)-(e) comprise separate programmed computers connected by a communication network.

Embodiments of the present invention provide a computer-readable media having stored thereon instructions for causing a computer to implement the methods and apparatuses described above.

Embodiments of the present invention provide systems using computing systems to find non-intuitive correlations among traits and backgrounds of individuals already successful in predetermined tasks, and then to build models incorporating such personal, professional and psychometric traits to use in seeking other individuals for such tasks. A model is referred to herein as a “Hero Persona” (Hero Persona is a trademark of Rewired Solutions, Inc.). The use of computer analysis and machine learning allows Hero Personas to include far greater complexity than is possible by hand, and to discover and use correlations that are not feasible with conventional human drafting of job descriptions. As examples, the technical requirements of a job, the location of the workplace, the team and company dynamics, and the work environment (e.g., hours, days, pressure level, etc.), can correlate with unexpected, and even unexplainable, combinations of traits. The present invention can determine, as an example, that success in a particular work position is correlated with (a) a combination of an advanced degree, enthusiasm for a particular sport, and use of Facebook as a preferred social media, or (b) a combination of a first level technical degree, a college minor in a foreign language, and extensive use of Twitter. The system finds such correlations empirically and automatically, and thus can discover correlations that would be obscured by conventional human prejudices.

The Hero Personas for a particular task (e.g., a project role or a job within a business) can then be used to develop communications plans to reach the desired individuals and to generate interest in the task. Similar machine learning and analysis techniques can be used to determine correlations between the desired individuals and the communications channels most likely to reach them, and the types of messaging most likely to be successful. As an example, the system can determine that a first Hero Persona is most likely to read advertisements that are repeated over a 7 day period and associated with specific web search inquiries, while a second Hero Persona is most likely to read advertisements that are continually updated, and presented in connection with Facebook memes. Optimal outreach for Hero Personas can also consider color, font, size, sound, artwork style (e.g., animated, drawing, or photo), subjects (e.g., nature, people, sports, popular media), time of day, dependence on geographic region, social media or advertising channel, and any other manageable consideration relative to the communications content or channel. The system can discover correlations that would be blocked by human prejudices, or that require details that are too numerous or obscure for manual management.

Hero Persona. A Hero Persona is a unique combination of personal, professional and psychometric traits that provides the framework for a candidate identification process. The personal and professional traits can be compiled through a computer-implemented survey process, by data mining of existing records such as individual background information, and individual performance and productivity records, and public records, or any combination of those, that allows the system to identify how to best target and engage potential candidates through social communication channels. The psychometric traits can be compiled through a validated assessment tool that determines what personality factors make people successful in a given role at a specific company.

By combining a plurality, or all, of these traits, the system is able to determine one or more unique Hero Persona(s) that serve(s) as the ideal image(s) of the candidate for a given role. The Hero Persona allows the system to design communications plans targeted at the Hero Persona(s), and to assess potential candidates' fit for a specific role responsive to their correlation with a Hero Persona.

Success Profile. The Success Profile is an input tool used to compile the traits needed to determine a Hero Persona. The Success Profile involves the gathering of a focused set of data points through a computer-implemented survey process, by data mining of existing records such as individual background information, and individual performance and productivity records, and public records, or any combination of those, that is then used to determine a Hero Persona. As an example, a Success Profile can comprise personal, professional, and psychometric traits.

Personal traits comprise information about where a person is in their family life cycle. Personal traits also include some basic information about their interests, hobbies, and core activities that characterize their lifestyle. Professional traits comprise work experience, education, certifications, and other data points relevant to the specific position being targeted. Psychometric traits comprise traits that affect how candidates will be scored in terms of personality and company cultural fit.

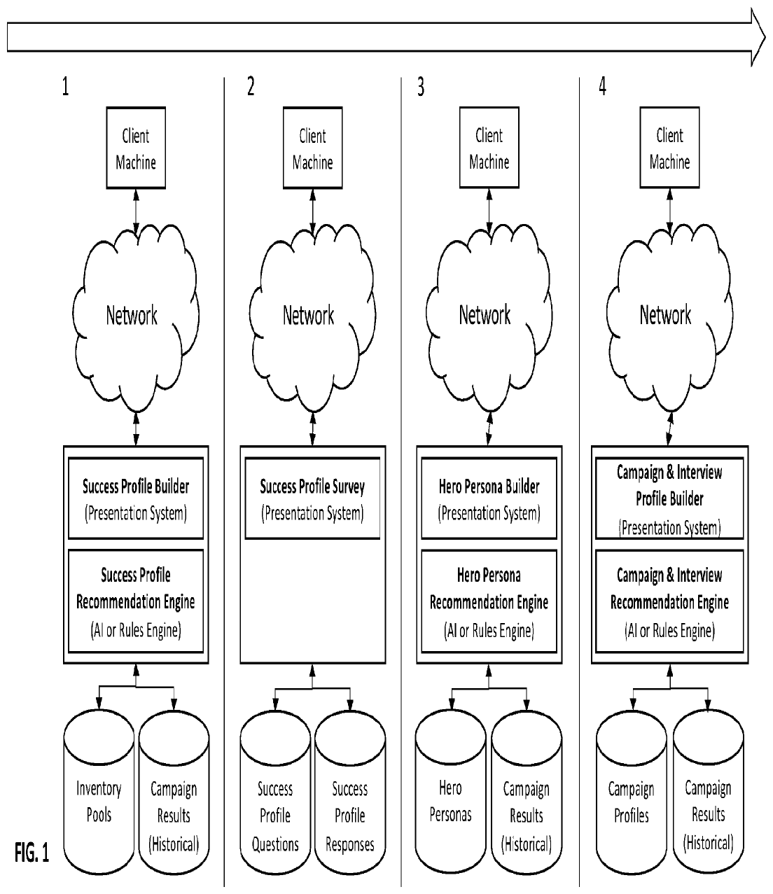

The Success Profile and Hero Persona determination systems can be implemented with computer processing techniques, as an example using the organizations shown in 1, 2, and 3 of FIG. 1.

Campaign Profile. The Campaign Profile is an input tool used to compile the components of a marketing or communication campaign that targets and qualifies potential candidates. The Campaign Profile comprises taking the Hero Personas and any historical campaign activity for the similar personas to create a targeted marketing strategy. This targeted marketing strategy includes the social media channels that potential candidates inhabit, the advertising used to target them, the qualifying questions that should be presented to them to obtain a Candidate Interview Profile, and the engagement messaging to communicate with them during the process.

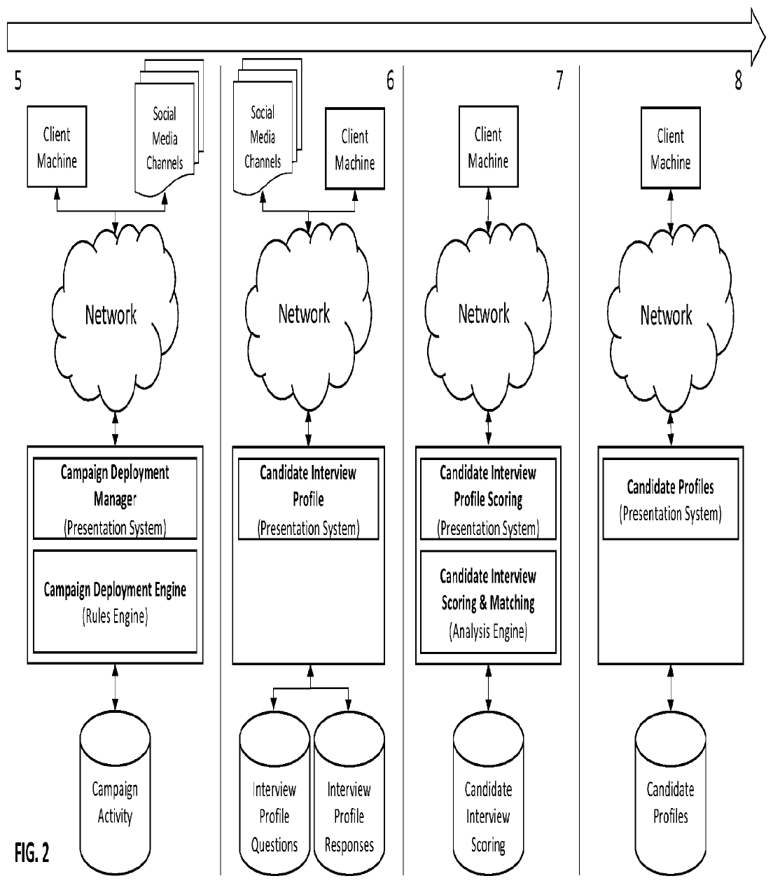

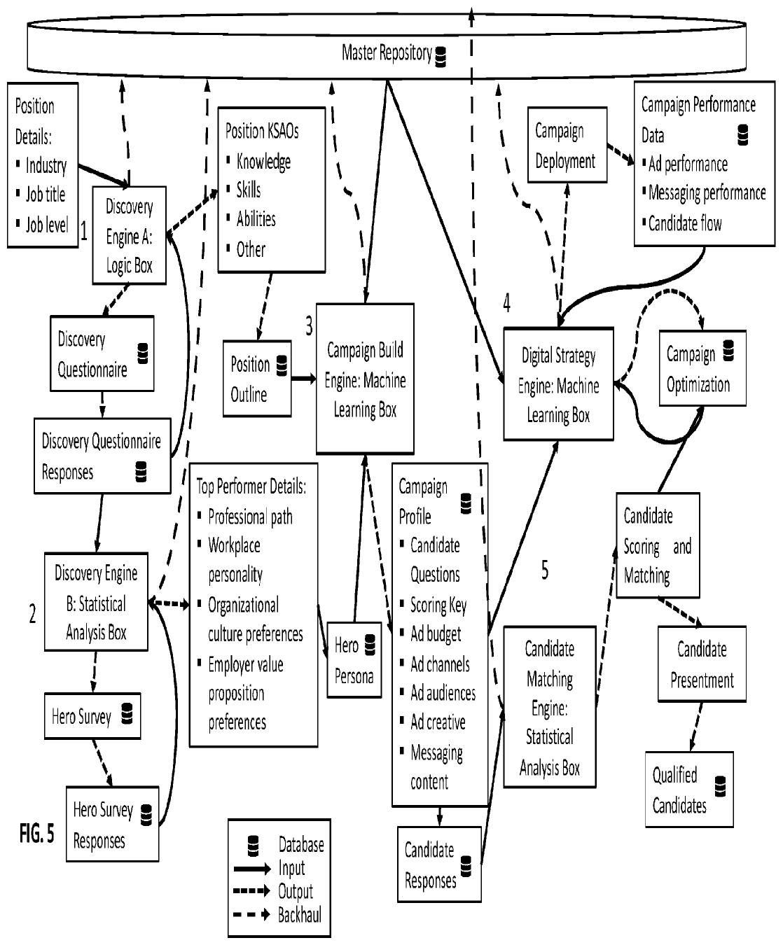

The Campaign Profile Builder, Deployment Manager, and Recommendations Engine can be implemented with computer processing techniques, as an example using the organizations shown in 4 of FIGS. 1 and 5 of FIG. 2.

Campaign Interview Profile. The Campaign Interview Profile is an input tool used to capture candidate responses to screening and qualifying questions. These responses are submitted by the candidate and captured with the system for subsequent scoring and matching. Candidate scoring data and matching data is combined with basic contact and demographic information regarding the candidate to create a Candidate Profile.

The Candidate Interview Profile presentment, capture, scoring, and matching system can be implemented with computer processing techniques, as an example using the organizations shown in 6 and 7 in FIG. 2.

The Candidate Profile Presentation Engine. The Candidate Profile Presentation Engine is an output tool that presents Candidate Profiles to hiring manager(s) and recruiters. The Candidate Profile provides basic contact information and assessment data enabling selection of the candidate for inclusion in the recruitment and hiring process.

The Candidate Profile Presentation Engine can be implemented with computer processing techniques, as an example using the organizations shown in 8 in FIG. 2.

The Campaign Profile Collect, Refinement, and Staging Engine aggregates the results of a campaign, sanitizes the data for reuse, and stages the data in format that can be reused as input to the Success Profile Recommendations Engine, Hero Persona Recommendations Engine, and Campaign Profile Recommendations Engine.

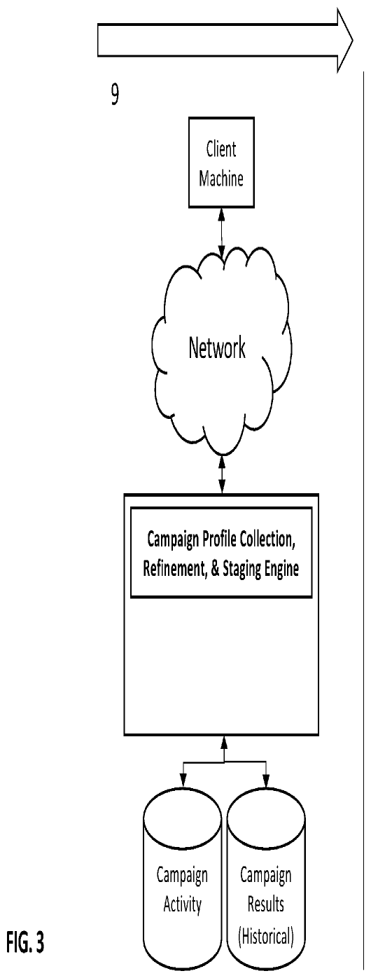

The Campaign Profile Collect, Refinement, and Staging Engine can be implemented with computer processing techniques, as an example using the organizations shown in 9 of FIG. 3.

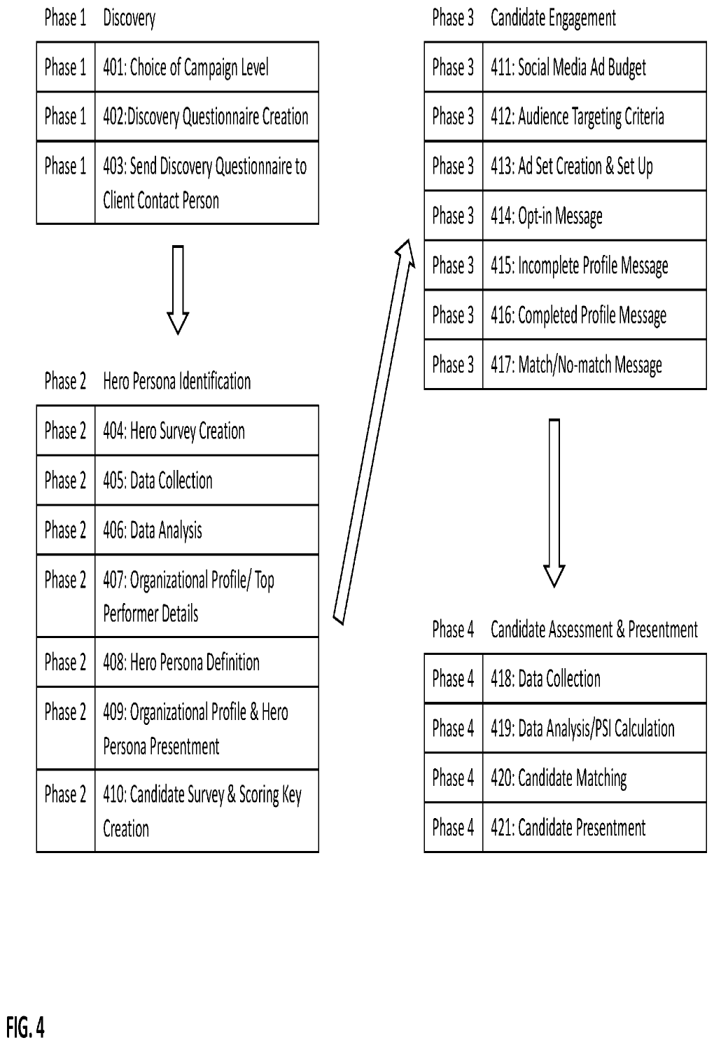

FIG. 4 is a process flow diagram of an example embodiment of the present invention. Some of the fields indicate steps that can be performed by human users of the automated system; others represent steps that can be performed by the automated system or inputs/results of machine learning and analysis.

Phase 1 (Discovery Phase) starts with the selection of a campaign level based on information that is relevant to the position that needs to be filled 401. The campaign level is determined by the main requirements and seniority level of the open position (e.g., degree, years of experience). As an example, there can be three campaign levels to choose from: (1) Campus (requires: a degree, little to no experience), (2) Entry Level (requires: no degree, some experience), (3) Professional (requires: a degree, ample experience). The person initializing the campaign can first choose which of the three levels is appropriate for the given campaign and then select the correct template within the platform accordingly. Other example embodiments can accommodate a single campaign level, or more than 3 campaign levels. Three levels are assumed in the description here for ease of discussion.

In the following step, the system creates the Discovery Questionnaire for the campaign 402. The Discovery Questionnaire can be standardized for each campaign level and assists in the collection of information that is needed in order to source the right candidates for a given position (i.e. the Position Outline). Questions that are relevant for the position in a given campaign can be chosen automatically via template selection. Modifications of the questions can be made, if necessary, to ensure applicability of the Discovery Questionnaire to a specific position.

Once the Discovery Questionnaire is created, it is sent to the campaign's client hiring authority 403.

Phase 2 (Hero Persona Identification Phase) starts with the creation of a customized Hero Survey 404. This survey does not collect any personally identifiable information (PII). It is used to gather job relevant information from top performers (i.e. Heroes) that hold a job position that is the same/or similar to the one that needs to be filled by the given campaign. The Hero Survey includes items that measure: (1) professional (2) social media preferences, (3) job relevant personality traits, (4) the company's organizational culture and (5) EVP characteristics.

Once the Hero Survey is created, it is deployed to a number of Heroes that were previously identified by the client of a given campaign 405.

The compiled data is then scored and analyzed by the system (406) in order to derive an Organizational Profile that represents Top Performer Details, as an example the following Top Performer Details: (1) professional path, (2) job relevant personality traits, (3) organizational culture and (4) EVP characteristics 407.

These Top Performer Details are used to derive a Hero Persona that a given campaign will target (i.e. a profile that is representative of all the job relevant top performer and organizational details for a given campaign) 408.

The identified Top Performer Details and Hero Persona summary are then presented to the campaign's client hiring authority 409.

Phase 2 concludes with the creation of the Candidate Survey and its Scoring Key 410. The content of the candidate survey is determined by two sources: (1) the most prevalent job personality traits that emerged from the Hero Survey data, and (2) job relevant information that was collected with the Discovery Questionnaire (i.e. the Position Outline). A customized candidate survey includes items that measure: (1) professional information, (2) job relevant KSAs, (3) job relevant personality traits, (4) organizational culture and (5) EVP preferences.

Phase 3 (Candidate Engagement) starts with the determination and allocation of a social media ad budget 411. A certain amount of the ad budget is reserved for testing of audiences and creative concepts. This discovery step provides basic metrics around the likely performance of a scaled campaign and shapes the allocation for the remaining amount of the total ad budget that goes towards running the social media ad campaign. Further factors that shape budget allocation are: (1) the industry, (2) the job type, (3) the campaign level and other factors/traits.

The second step of the Candidate Engagement Phase involves the establishment of criteria for social media audience targeting 412. For example, these criteria can consist of: (1) the basic minimum requirements for the job position that needs to be filled, (2) current and past job roles, (3) specific skills/specializations, (4) certifications/licenses, (5) job seniority, group memberships, (6) interests, and (7) locations. These criteria are selected with the resulting audience size in mind. A balance is struck between a relevant but sizeable audience in order to ensure the success of the social media advertisements. Small audience sizes and criteria violating EEOC laws are avoided at all times.

The next step focuses on the creation and set up of an advertisement set 413. This step involves: (1) the selection of appropriate social media channels, (2) the selection of advertisement types (i.e. videos, images, direct messages etc.), (3) the creation of a Landing Page, and (4) the creation of the advertisement creatives. The selection of appropriate social media channels is based on the level of a given campaign (e.g., Campus, Entry Level, Professional) and the allocation of the social media budget that was determined in the first step 411 of phase 3. The subsequent selection of advertisement types depends on the selected social media channel(s). The Landing Page comprises the following elements: (1) minimum job requirements, (2) benefit copy, (3) three “Call to Action” (CTA) buttons that link to the candidate survey, (4) an image selected from a standardized set of images based on campaign level. Ad creatives depend on the selected advertisement type. They are created based on a pool of standardized templates that include CTAs and images. These templates are chosen based on historical campaign data and the results of audience and creative concept testing (performed in the beginning of Phase 3) that indicate what content is most likely to resonate with the targeted audience.

Once the advertisement sets are created, set up, and deployed, the Candidate Engagement Phase transitions into the candidate messaging steps. This part of the Candidate Engagement Phase comprises a sequence of automated message types, for example the following four message types: (1) Opt-in Message, (2) Incomplete Profile Message, (3) Completed Profile Message, and (4) Match/No Match Message. Candidates receive the first message (i.e. Opt-in Message) after they have registered their account and agreed to the data privacy and terms of use 414. This message serves two purposes: (1) it informs the candidates that they have opted-in and provided their consent, and (2) it serves as email or mobile phone number verification.

After registering their account, candidates are asked to complete the candidate survey (see step 418). If they do not finish the survey, they can be sent an Incomplete Profile Message that reminds them to do so 415. Candidates with incomplete profiles will receive this message up to three times during a 15-day period: (1) first attempt (on day 1), (2) second attempt (on day 4), (3) final attempt (day 15). Candidates that finish their profile after the first or second attempt message will not receive any subsequent Incomplete Profile Messages thereafter.

After completing their profiles, candidates receive a Complete Profile Message that informs them that they have finished and submitted their profile 416.

Completed candidate profiles are then automatically run through a candidate matching step (see step 420). Based on the results derived from this step candidates either receive a Match or No-Match Message 417. This message: (1) informs them about their match/no-match status for the given job opportunity, and (2) functions as a final opt-in/opt-out option that asks candidates for their permission to forward their information to the client of the given campaign.

In the first step of Phase 4 (Candidate Assessment & Presentment) data is collected with the customized Candidate Survey. This happens as soon as the campaign is deployed and the system is ready to receive candidate responses 418.

In the next step, the compiled responses are scored and analyzed in order to derive an individual Profile for each candidate that reflects their: (1) KSAs, (2) their most prevalent job personality traits, and (3) their organizational culture and (4) EVP preferences 419.

In the candidate matching step, each Candidate Profile is then compared against the previously determined Organizational Profile 420. This is done in order to derive Profile Similarity Indices (PSIs) that indicate the similarity of each Candidate Profile with the Organizational Profile for the: (1) position's mandatory KSAs, (2) identified job relevant personality characteristics, and (3) organizational culture and (4) EVP preferences. These PSI's are the basis for the determination of each candidate's fit with the given position and company. PSI's are further grouped together in order to determine each candidate's: (1) Person-Job Fit (based on PSI's of KSAs and job relevant personality characteristics), (2) Person-Organization Fit (based on PSI's of Organizational Culture and EVP preferences), and (3) Overall Fit (based on Person-Job and Person-Organization Fit PSIs). Based on their Overall Fit candidates are identified as either a “match” or a “no-match”. Candidates can be classified as a match when they display a strong congruence (i.e. high PSIs) with a given company's Organizational Profile. Conversely, candidates can be classified as a no-match when they display only a weak or non-existent congruence with the Organizational Profile (i.e. low PSIs).

Matching candidate profiles are subsequently presented to a client's hiring manager or an appropriate company representative via Candidate Abstract 421. The hiring manager is then able to determine whether they would like to proceed with the position application process. In some cases, the company might request that matching candidates be routed directly to their applicant tracking system for formal application submission. While matches are passed to the campaign administrator, no-matches are stored for potential future use.

FIG. 5 is a system diagram illustrating the steps within the overall process (described in FIG. 4) that are operated by the automated system. These steps are the results of machine learning and data analysis processes, visualized as black boxes (i.e. engines steps 1-5) in FIG.5. Each of these engines backhauls essential information learned throughout the course of a campaign to the system's master repository. This master repository information is organized in the system's database, which grows with each additional campaign that is run by the system. By providing input into the Campaign Build Engine (Step 3) and the Digital Strategy Engine (Step 4), the Master Repository database not only serves important campaign optimization purposes but also as training data set for all of the modeling and machine learning that occurs within the platform.

Step 1 (Discovery Engine A: Logic Box) implements the automation of the Discovery Phase (Phase 1, FIG. 4). The primary input for this step consists of the position details (i.e. industry, job title, job level). With this input, Discovery Engine A utilizes rules to produce the following primary and secondary outputs: (1) the Discovery Questionnaire (primary output) that is utilized to collect (2) the Discovery Questionnaire Responses (secondary output), which get fed back as secondary input into Discovery Engine A, that subsequently outputs (3) Position KSAOs: knowledge, skills, abilities, and other (primary output). Based on these Position KSAOs the system creates a Position Outline. The Discovery Questionnaire, the responses that are collected with it and the Position Outline are all organized in the system's database.

Step 2 (Discovery Engine B: Statistical Analysis Box) implements the automation of the Hero Persona Identification Phase (Phase 2, FIG. 4). With the Discovery Questionnaire Responses as primary input, Discovery Engine B produces (1) the Hero Survey (primary output). The Hero Survey is utilized to collect (2) the Hero Survey Responses (secondary output). Both the Hero Survey and the Hero Survey Responses are stored in the system's database. The Hero Survey Responses are then fed back as a secondary input into the Discovery Engine B, that performs statistical analyses of the aggregated Hero Survey Response data and subsequently outputs (3) the Top Performer Details: professional path, workplace personality, organizational culture preferences, and employer value proposition preferences (primary output). These Top Performer Details summarize the Hero Survey Responses in terms of descriptive statistics (i.e. mean, median, mode, range, variance, standard deviation). The data points that comprise the Top Performer Details are then then arranged by the system into a Hero Persona. The Hero Persona data is stored in the system's database.

Step 3 (Campaign Build Engine: Machine Learning Box) implements the automation of the candidate survey creation and the Candidate Engagement Phase (Phase 3, FIG. 4). The input for Step 3 comprises three sources: (1) the Hero Persona, (2) the Position Outline, and (3) the Master Repository. With these inputs, the Campaign Build Engine utilizes machine learning to produce the Campaign Profile (primary output) that includes: Candidate Questions, Scoring Key, Ad Budget, Ad Channels, Ad Audiences, Ad Creative, and Messaging Content. The system decides which Ad Budget, Ad Channels, Ad audiences, Ad Creative and Messaging Content to deploy. In the case of Ad Creative and Messaging Content, the system is choosing from a pool of existing templates. These decisions are based on historical campaign performance data, a variety of machine learning techniques and the Position Outline that reflects important information such as the industry, job level, job title and KSAOs. The Candidate Questions and the Scoring Key are created and then utilized to collect the Candidate Responses (secondary output). All of which are stored in the system's database.

Step 4 (Digital Strategy Engine: Machine Learning Box) implements the automation of the Campaign Deployment and Optimization Process. The primary input for Step 4 comes from two sources: (1) the Campaign Profile, and (2) the Master Repository. With these inputs and the utilization of machine learning, the Digital Strategy Engine initiates the Campaign Deployment (primary output). After a campaign has been deployed, the systems starts to collect Campaign Performance Data (secondary output): ad performance, messaging performance, candidate flow. The Campaign Performance Data gets fed back as secondary input into the Digital Strategy Engine that subsequently initiates the Campaign Optimization (primary output). The Campaign Optimization receives further input in the form of Candidate Scoring and Matching Information (output of Step 5) after which it then feeds back as secondary input into the Digital Strategy Engine. Both the Campaign Performance and Campaign Optimization Data are stored in the system's database.

Step 5 (Candidate Matching Engine: Statistical Analysis Box) implements the automation of the Candidate Assessment & Presentment Phase (Phase 4, FIG. 4). The input for Step 5 comprises the Candidate Responses that were generated as secondary output of Step 3. The Candidate Matching Engine performs a set of statistical analyses for each submitted candidate profile in order to derive: (1) descriptive statistics, and (2) profile similarity indices (PSI) that indicate each candidate's level of fit with the determined Hero Persona. In order to calculate the PSIs the system calculates the correlation coefficients for each Candidate Profile with the Hero Persona Profile. The subsequent output of these statistical analyses is the Candidate Scoring and Matching (primary output) which results in the Candidate Presentment (secondary output) of Qualified Candidates (final output). The Candidate Scoring and Matching data and all qualified candidates are stored in the systems database.

Implementation. Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of a special-purpose computer, programmable data processing apparatus, processor, processor architecture, and so on.

It will be understood that a computer can include a computer-readable storage medium and that this medium can be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the systems as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

According to an embodiment of the present invention, a data store can be comprised of one or more databases, file storage system, relational data storage system or any other data system or structure used to store data, preferably in a relational manner. In an embodiment of the present invention, the data store can be a relational database, working in conjunction with a relational database management system (RDBMS) for receiving, processing and storing data. In an embodiment, the data store can comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof can be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions can include computer executable code. A variety of languages for expressing computer program instructions are possible, including without limitation C, C++, Java, JavaScript, assembly language, Lisp, HTML, Perl, and so on. Such languages can include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads can be processed more or less simultaneously to enhance utilization of the processor and to facilitate substantially simultaneous functions. By way of implementation, any and all methods, program codes, program instructions, and the like described herein can be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. It is possible to modify or customize general-purpose systems to be used with programs in accordance with the teachings herein, or it might prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages can be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware specialized through computer instructions; and so on—any and all of which can be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations can depict a step, or group of steps, of a computer-implemented method. Further, each step can contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described can be utilized and presented in a multitude of languages. Individual systems can be presented in one or more languages and the language can be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for recruiting employment candidates likely to be successful in a targeted position, comprising:
(a) a success profile builder, comprising a programmed computer that determines characteristics of individuals in positions similar to the targeted position from surveys of such individuals, which individuals have been observed to have desirable performance and desirable tenure in such positions;
(b) a hero persona builder, comprising a programmed computer that determines correlations between characteristics determined by the success profile builder, characteristics of the position, and likelihood of success in the targeted position to produce one or more hero personas for the targeted position, and that determines communications channels likely to engage individuals who are similar to a hero persona;
(c) a campaign builder, comprising a programmed computer that determines communications regarding the position from a hero persona, and matches the communications to communications channels for the hero persona.

2. A system as in claim 1, wherein the campaign builder monitors engagement by potential candidates with the communications, and adjusts the communications contents, the channels, the timing of communications, or a combination thereof, responsive to such monitored engagement.

3. A system as in claim 1, wherein the hero persona builder comprises a computer-implemented machine learning tool.

4. A system as in claim 1, wherein the success profile builder comprises a computer-implemented survey, and a computer-implemented data mining tool that mines personal, professional, and psychometric traits of current employees, candidates, or a combination thereof.

5. A system as in claim 1, wherein the campaign builder comprises computer-implemented machine learning that determines preferred advertising content and channels responsive to the hero persona(s) and characteristics of similar personas in other campaigns.

6. A method of recruiting employment candidates likely to be successful in a targeted position, comprising:
(a) identifying characteristics likely to be relevant to success in performance and in tenure in the targeted position, or to successful communication with a candidate;
(b) producing a success profile, comprising personality, professional, demographic, and social media characteristics, from the characteristics determined in step (a);
(c) identifying individuals who are in positions similar to the targeted position and have demonstrated success in such positions, and building a database comprising each such individual's quantifiable facts relative to the success profile;
(d) using a computer model to determine from the database correlations among specific facts in the success profile and likelihood of success in the targeted position;
(e) using a computer model to determine from the correlations one or more hero personas, where a hero persona comprises a specific set of facts, or range of facts, from the success profile, that is likely to correlate with success in the targeted position;
(f) using a model such as a k-nearest neighbor model to identify which persona(s) are most aligned with individuals currently successful in the position;
(g) using the persona(s) identified, determining advertising content and channels likely to reach individuals likely to be successful in the position;
(h) accepting input from candidates, and determining whether each candidate is desirable responsive to the candidate's input and the success profile.

7. An apparatus for identifying and communicating with candidates for a position, comprising:
(a) a first discovery engine comprising a programmed computer configured to accept a specification of the position, and to use programmed rules to produce a discovery questionnaire, and then to accept responses to the discovery questionnaire and produce a position outline;
(b) a second discovery engine comprising a programmed computer configured to accept response to the discovery questionnaire and produce a hero survey, and then to collect responses to the hero survey and to analyze those responses and characteristics of the respondents and produce a hero persona;
(c) a campaign build engine, comprising a programmed computer configured to accept the hero persona, the position outline, and specification of other communication campaigns, and produce a campaign profile comprising three or more of candidate questions, scoring key, ad budget, ad channels, ad audiences, ad creative, and messaging content;
(d) a candidate matching engine, comprising a programmed computer configured to accept information from a prospective candidate and the hero persona and produce a profile similarity index that corresponds to the candidate's fit with the hero persona;
(e) a digital strategy engine comprising a programmed computer configured to accept the campaign profile and the position outline, the hero persona, or both; and to deploy the campaign according to the campaign profile, where deploying the campaign comprises one or more of placing ads, communicating to prospective candidates, accepting profile similarity indices from prospective candidates to adjust the campaign profile responsive to the profile similarity indices.

8. (canceled)

9. The apparatus of claim 7, wherein the programmed computer in at least two of elements (a)-(e) is the same programmed computer.

10. The apparatus of claim 7, wherein the programmed computer of at least two of elements (a)-(e) comprise separate programmed computers connected by a communication network.

11. A computer-readable media having stored thereon instructions for causing a computer to implement the apparatus of claim 7.

12. An apparatus as in claim 7, comprising a non-transitory data storage having stored therein instructions for causing a programmable computer to implement the elements listed in claim 7.

13. (canceled)
